(19) United States
(12) Patent Application Publication
(10) Pub. No.: US 2019/0095442 A1
(43) Pub. Date: Mar. 28, 2019

(54) TECHNIQUES TO ENABLE EARLY DETECTION OF SEARCH MISSES TO ACCELERATE HASH LOOK-UPS

(71) Applicant: INTEL CORPORATION, SANTA CLARA, CA (US)

(72) Inventor: ANTONIO FISCHETTI, Limerick (IE)

(73) Assignee: INTEL CORPORATION, SANTA CLARA, CA (US)

(21) Appl. No.: 15/715,394

(22) Filed: Sep. 26, 2017

(51) Int. Cl. G06F 17/30

(52) U.S. Cl. CPC G06F 17/3033; G06F 17/30442; G06F 17/30339

(57) ABSTRACT

Various embodiments are generally directed to techniques to determine a profile of locations of misses among a plurality of iterative locations for a plurality of search keys, the plurality of locations corresponding with sub-keys within the search keys, the profile of location of misses based on comparisons of sub-key hash values with element hash values indicating sub-key hash values and corresponding element hash values do not match, wherein the sub-key hash values are based on sub-keys of the plurality of search keys, and the element hash values are based on elements of entries of a table, utilize the profile of locations of misses to identify a location to perform a direct match operation, and perform the direct match operation at the location, the direct match operation to determine at the location whether a sub-key of a search key matches an element of one or more entries in the table.

### TECHNICAL FIELD

Embodiments described herein generally include techniques to enable early detection of search misses to accelerate hash looks-ups. More specifically, embodiments performing training to determine one or more locations having the highest probability of causing a miss and using the locations to perform direct matches.

### BACKGROUND

Hash tables are a fundamental building block in diverse applications such as databases, search engines, statistics processing, virtual switching, dynamic script languages, and so forth. Hash tables are a family of containers that associate keys with values. Hash tables calculate placement position for an item stored in an entry of the table, i.e., a bucket, using its hash value and a current capacity of the container. However, hash lookups can deeply affect the performance of systems and applications and can easily become a bottleneck when massive hash table operations are carried out.

### BRIEF DESCRIPTION OF THE DRAWINGS

FIG. 1A illustrates an example of a first system.

FIG. 1B illustrates an example of a search key.

FIG. 2 illustrates an example of a logic flow to process a search key.

FIG. 3 illustrates an example of a logic flow to perform a training procedure.

FIG. 4 illustrates an example of a logic flow process a search key.

FIGS. 5A-D illustrates an example of processing flows while performing a training procedure.

FIGS. 6A/6B illustrates examples of processing flows while processing search keys.

FIG. 7 illustrates an example of a logic flow.

FIG. 8 illustrates an example embodiment of a computing architecture.

### DETAILED DESCRIPTION

Embodiments described herein generally include techniques to enable early detection of search misses to accelerate hash looks-ups. More specifically, embodiments perform training to determine one or more locations having the highest probability of causing a miss in a table, e.g. a failed hash look up. During non-training processing of search keys a direct match operation to determine whether a sub-key matches an element of at least one of one or more entries in the hash table at the location having the greatest number of misses determined during the training, for example. If a sub-key does not match an element a miss occurs and the processing of the remaining sub-keys, e.g. performing hash functions, of the search key may halt, and the entire operation may be indicated as a miss or failure. Thus, misses may be detected earlier than and use less processing cycles and computing resources than when all of the sub-key hash values are generated for the search key. However, if a hit occurs, the remaining sub-key hash values may be generated, and the search key may be processed as described herein. These and other details will become more apparent in the following description.

Reference is now made to the drawings, wherein like reference numerals are used to refer to like elements throughout. In the following description, for purposes of explanation, numerous specific details are set forth to provide a thorough understanding thereof. It may be evident, however, that the novel embodiments can be practiced without these specific details. In other instances, well-known structures and devices are shown in block diagram form in order to facilitate a description thereof. The intention is to cover all modifications, equivalents, and alternatives consistent with the claimed subject matter.

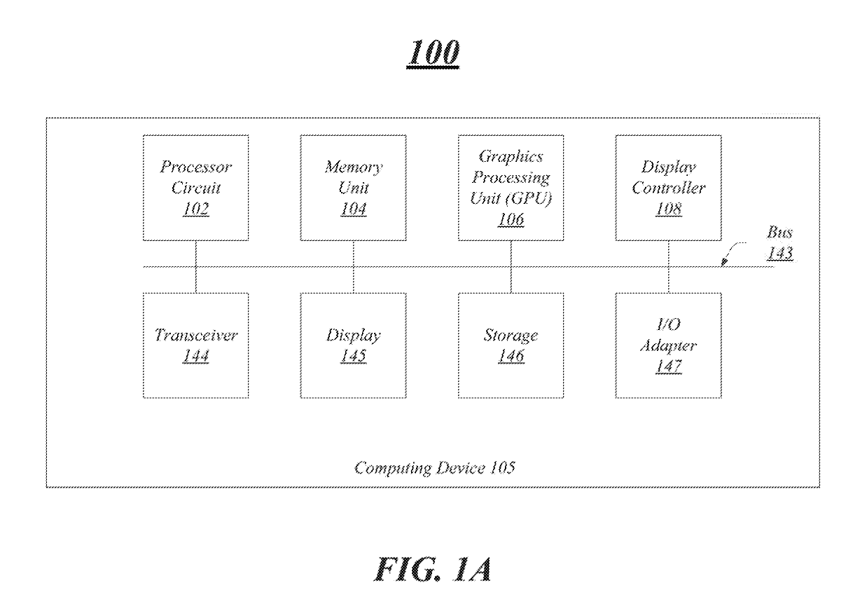

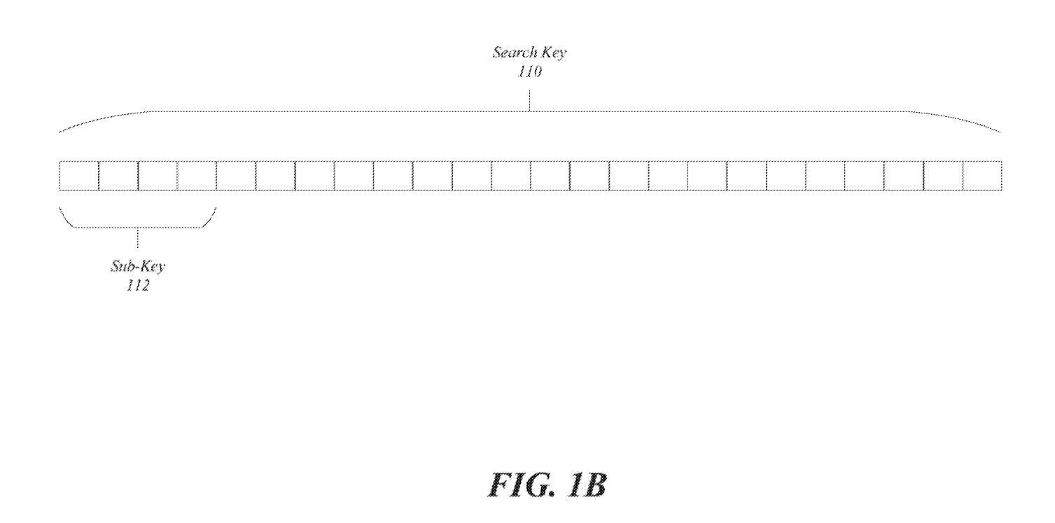

FIG. 1 illustrates one embodiment of a system 100. In various embodiments, system 100 may be representative of a system or architecture suitable for use with one or more embodiments described herein.

As shown in FIG. 1, system 100 may include multiple elements. One or more elements may be implemented using one or more circuits, components, registers, processors, software subroutines, modules, or any combination thereof, as desired for a given set of design or performance constraints. Although FIG. 1 shows a limited number of elements in a certain topology by way of example, it can be appreciated that more or fewer elements in any suitable topology may be used in system 100 as desired for a given implementation. The embodiments are not limited in this context.

In various embodiments, system 100 may include a computing device 105 which may be any type of computer or processing device including a personal computer, desktop computer, tablet computer, netbook computer, notebook computer, laptop computer, server, server farm, blade server, or any other type of server, and so forth.

In various embodiments, computing device 105 may include processor circuit 102. Processor circuit 102 may be implemented using any processor or logic device. The processing circuit 102 may be one or more of any type of computational element, such as but not limited to, a microprocessor, a processor, central processing unit, digital signal processing unit, dual core processor, mobile device processor, desktop processor, single core processor, a system-on-chip (SoC) device, complex instruction set computing (CISC) microprocessor, a reduced instruction set (RISC) microprocessor, a very long instruction word (VLIW) microprocessor, or any other type of processor or processing circuit on a single chip or integrated circuit. The processing circuit 102 may be connected to and communicate with the other elements of the computing system via an interconnect 143, such as one or more buses, control lines, and data lines. In embodiments, the processing circuit 102 may include one or more cores 110 and processing circuitry to process information for the compute device 105. In some embodiments, the processor circuit 102 may be an accelerator device, such as a field-programmable gate array (FPGA) device, an application-specific integrated circuit (ASIC) device, a co-processor device, a math co-processor, and so forth. The processing circuit 102 may be part of a multi-chip package (MCP) and is included with other processing circuitry, e.g. cores, memory controllers, and accelerator devices.

In one embodiment, computing device 105 may include a memory unit 104 to couple to processor circuit 102. The memory unit 104 may be coupled to the processor circuit 102 via communications bus 143, or by a dedicated communications bus between processor circuit 102 and memory unit 104, as desired for a given implementation. The memory unit 104 may be implemented using any machine-readable or computer-readable media capable of storing data, including both volatile and non-volatile memory. In some embodiments, the machine-readable or computer-readable medium may include a non-transitory medium. The embodiments are not limited in this context.

The memory unit 104 be one or more of volatile memory including random access memory (RAM) dynamic RAM (DRAM), static RAM (SRAM), double data rate synchronous dynamic RAM (DDR SDRAM), SDRAM, DDR1 SDRAM, DDR2 SDRAM, SSD3 SDRAM, single data rate SDRAM (SDR SDRAM), and so forth. Embodiments are not limited in this manner, and other memory types may be contemplated and be consistent with embodiments discussed herein. For example, the memory 105 may be a three-dimensional crosspoint memory device, or other byte addressable write-in-place nonvolatile memory devices. In embodiments, the memory devices may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin-transfer torque (STT)-MRAM, a spintronic magnetic junction memory based device, a magnetic tunneling junction (MTJ) based device, a DW (Domain Wall) and SOT (Spin-Orbit Transfer) based device, a thyristor-based memory device, or a combination of any of the above, or other memory.

Computing device 105 may include a graphics processing unit (GPU) 106, in various embodiments. The GPU 106 may include any processing unit, logic or circuitry optimized to perform graphics-related operations as well as the video decoder engines and the frame correlation engines. The GPU 106 may be used to render 2-dimensional (2-D) and/or 3-dimensional (3-D) images for various applications such as video games, graphics, computer-aided design (CAD), simulation and visualization tools, imaging, etc. Various embodiments are not limited in this manner; GPU 106 may process any type of graphics data such as pictures, videos, programs, animation, 3D, 2D, objects images and so forth.

In some embodiments, computing device 105 may include a display controller 108. The display controller 108 may be any type of processor, controller, circuit, logic, and so forth for processing graphics information and displaying the graphics information. The display controller 108 may receive or retrieve graphics information from one or more buffers. After processing the information, the display controller 108 may send the graphics information to a display.

In various embodiments, system 100 may include a transceiver 144. Transceiver 144 may include one or more radios capable of transmitting and receiving signals using various suitable wireless communications techniques. Such techniques may involve communications across one or more wireless networks. Exemplary wireless networks include (but are not limited to) wireless local area networks (WLANs), wireless personal area networks (WPANs), wireless metropolitan area network (WMANs), cellular networks, and satellite networks. In communicating across such networks, transceiver 144 may operate in accordance with one or more applicable standards in any version. The embodiments are not limited in this context.

In various embodiments, computing device 105 may include a display 145. Display 145 may constitute any display device capable of displaying information received from processor circuit 102, graphics processing unit 106 and display controller 108.

In various embodiments, computing device 105 may include storage 146. Storage 146 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In embodiments, storage 146 may include technology to increase the storage performance enhanced protection for valuable digital media when multiple hard drives are included, for example. Further examples of storage 146 may include a hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of DVD devices, a tape device, a cassette device, or the like. The embodiments are not limited in this context.

In various embodiments, computing device 105 may include one or more I/O adapters 147. Examples of I/O adapters 147 may include Universal Serial Bus (USB) ports/adapters, IEEE 1394 Firewire ports/adapters, and so forth. The embodiments are not limited in this context.

In embodiments, the computing device 105 including logic in the processor circuit 102 and/or instructions in the memory unit 104 may be capable of computing hash values and performing hash lookups in hash tables based on search keys, in particular, for search keys with sizes greater than the number of bytes that can be processed by the hash-function. A search key may be a combination of alphanumeric numbers and symbols that may be run through a hash function to produce a search key hash value. In some instances, the search key hash value may match an index or hash value associated with an entry in a hash table. The search key may be used to perform a hash lookup in the hash table, which may be a data structure that implements an associative array abstract data type, e.g. a structure that can map the search keys to values. The hash tables may be used for fingerprinting, e.g. to detect duplicate data or uniquely identify files, and as checksums to detect accidental data corruption. In some instances, the search key may be larger than the number of bytes that may be processed by a hash function. In these instances, the hash computation needs to be performed through a number of iterations. FIG. 1B illustrates one example search key 110 having a number of sub-keys 112, wherein the size of the search key is greater than the number of bytes that can be processed by the hash-function. Each of the sub-keys 112 may be the portion of the search key 110 that may be processed during one hash iteration. Each of the iterations may consume a number of processing cycles and can affect the performance of applications. Thus, a hash lookup can become a bottleneck when a large number of hash table operations are carried out. Embodiments discussed herein improve these and other deficiencies by detecting misses earlier.

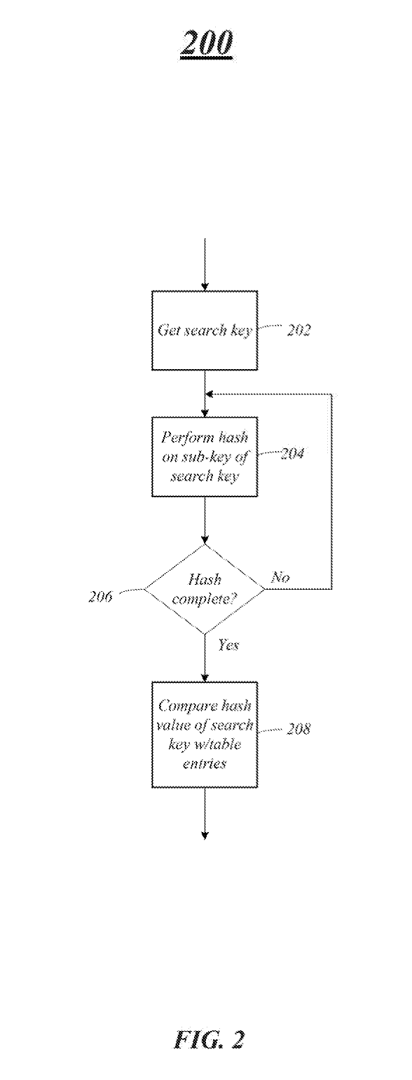

FIG. 2 illustrates example logic flow diagram 200 to perform a hash lookup without using a training procedure. The logic flow 200 may illustrate operations performed by a computing device, and in particular process circuitry of a computing device.

At block 202, the logic flow 200 may include getting a search key to perform a hash table look up. As mentioned, the search key may be made up of any combination of alphanumeric symbols and may be longer than what is capable of being processed by a hash function. The search key may be divided into a number of sub-keys having a size that is capable of being processed by the hash function. The sub-keys may be processed in iterations, where each iteration performs the hash function on a particular sub-key, as illustrated in FIG. 2.

The logic flow 200 may include performing a hash function on a sub-key of the search key at block 204. The hash function may be any hash function, and embodiments are not limited in this manner. Examples of hash functions include, but are not limited to, Murmur hash, Jenkins hash, Zobrist hash, Pearson hash, Buz hash, City hash, Spooky hash, Bernstein hash, Highway hash, and so forth.

At block 206, embodiments may include determining whether a hash value for the search key is complete, e.g. each of the sub-key hash values has been determined for each of the sub-keys of the search key. If the hash value is not complete, the logic flow 200 may include performing operations 204 and 206 until sub-key hash values have been generated for each of the sub-keys of the search key. If the hash value for the search key is complete at block 206, the logic flow 200 may include comparing the search key with the table entries pointed by the hash value—and possible jumps to manage collisions—to determine if the search key is in the table. If the entry is empty or it doesn't match with the search key, the hash table lookup may be a miss (a failure). If the found entry matches the search key the hash table lookup is completed (i.e. hit).

As illustrated in this example, the determination as to whether the search key is a hit or miss in the hash table lookup cannot be completed until a sub-key hash value is generated for each of the sub-keys of the search during a number of iterations. Each of the sub-keys 112 may be the portion of the search key 110 that may be processed during one hash iteration. Each of the iterations may consume a number of processing cycles and can affect the performance of applications. Thus, embodiments discussed herein may include performing a training procedure or learning mechanism to perform modelling or determine a profile of locations of misses among a plurality of iterative locations using a plurality of search keys. The model or profile may be used to detect a miss prior to every sub-key hash being generated for a search key. The learning procedure may determine the probability that a sub-key can match a corresponding portion or element of entries in the hash table. Moreover, the training procedure may include determining the probabilities for each of the locations of misses based on a comparison of sub-key hash values indicating corresponding element hash values not matching. Based on the profile of locations of misses, a location of a miss correspond with the greatest number of misses may be determined, e.g. an iteration having the highest probability of a miss for a given hash table with entries. Further, a probability for each location may be determined based on the profile. As will be discussed in more detail, a direct match operation may be performed in a decreasing order of probability for the locations of misses. During the training procedure, a number of search keys may be used to determine probabilities of each of the iterations has of failing or generating a miss.

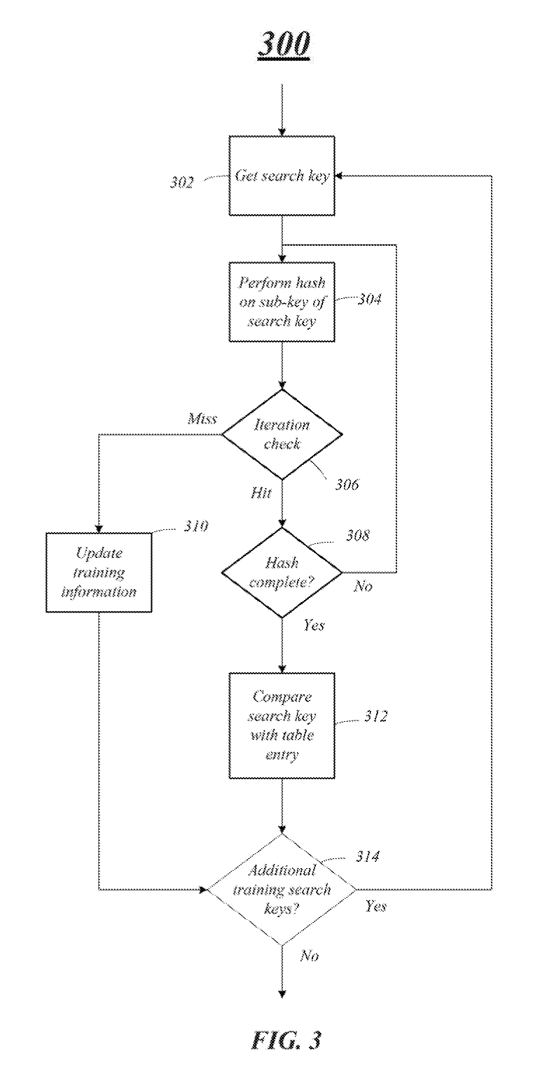

FIG. 3 illustrates an example logic flow 300 to perform a learning procedure to generate a profile of locations of misses, e.g. determining a probability that a miss will occur for each iteration of a plurality of iterations across a plurality of search keys. Thus, the location having the most misses, the next most misses, and so forth may be determined from the profile. In one example, the profile may indicate that a miss occurs the most number of times during the third iteration when processing a number of search keys. Thus, the location having the most misses is the third iteration. The logic flow 300 may be repeated a number of times, each using a different training search key with the same hash table. The number of times may be determined by a user, a computer setting, and so forth. For example, the number of search keys used for training may be based on a number needed such that the results are statistically significant. Moreover, the training procedure may be initiated and run every time a system starts, and/or changes are made to the hash table.

At block 302, the logic flow 300 may include getting a search key to perform a training procedure for a hash table. The search key may be made up of any combination of alphanumeric symbols and may be longer than what is capable of being processed by a hash function. In embodiments, the search key be generated by extracting the security key from incoming packets when utilizing virtual switching (vSwitching) applications. The search key for other applications using hash searches may be based on extracted fields from the input to be processed or the entire input itself. The search key may be divided into a number of sub-keys having a size that is capable of being processed by the hash function. The sub-keys may be processed in iterations, where each iteration performs the hash function on a particular sub-key.

The logic flow 300 may include performing a hash function on a sub-key of the search key at block 304. The hash function may be any hash function and embodiments are not limited in this manner. Examples of hash functions include, but are not limited to, Murmur hash, Jenkins hash, Zobrist hash, Pearson hash, Buz hash, City hash, Spooky hash, Bernstein hash, Highway hash, and so forth.

At block 306, embodiments may include determining whether the sub-key hash value generated based on the hash function performed on a sub-key matches any corresponding element hash values of elements of entries in the hash table. If the sub-key hash value does not match any element hash values, a miss occurs. At block 310, the training information may be updated with the location of the miss. For example, a table tracking a number of misses for each iteration may be updated. Each iteration may be associated with a counter in the table to track the misses at that specific iteration, for example.

In embodiments, if a hit occurs at block 306, the logic flow 300 may include determining whether a hash value for the search key is complete, e.g. each of the sub-key hash values has been determined for each of the sub-keys of the search key at block 308. If the hash value is not complete, the logic flow 300 may include performing another iteration and operations 304 and 306 and possibly 310 until sub-key hash values have been generated for each of the sub-keys of the search key or a miss occurs. If the hash value for the search key is complete at block 308, the logic flow 300 may include comparing the hash value of the search key with the table entry pointed to by the hash value to determine if the hash value is in the table at block 312. If no entry exists at the location pointed to by the hash value, or the entry does not match the search key a miss occurs. However, if the search key is in the in the table at the location and a match occurs the hash table lookup may be completed. At block 314, a determination may be made as to whether any additional search keys are available for training. If not, the training procedure may halt. If so, the logic flow 300 may be repeated until all of the search keys for training are processed.

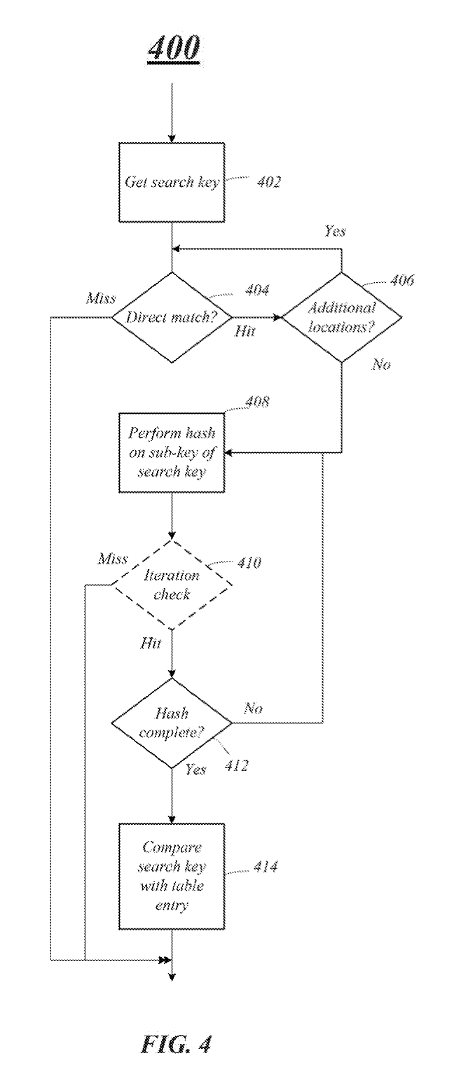

FIG. 4 illustrates an example logic flow 400 to determine whether a search key hits or misses an entry in a hash table. In the illustrated example, the logic flow 400 may utilize a training procedure to determine one or more iterations which have the most misses based on a profile generated as a result of the training procedure. The profile may be used to perform direct match operations to attempt to determine whether a search key is a hit or miss earlier in the processing cycle, e.g. before a number of iterations to calculate sub-key hash values are performed.

At block 402, the logic flow 400 may include getting a search key to perform a lookup in a hash table. The search key may not be processed by a hash function in a single iteration. Thus, the search key may be divided into a number of sub-keys having a size that is capable of being processed by the hash function. In one example, the size of the sub-key may be the maximum size that a particular hash function is capable of being processed. The sub-keys may be processed in iterations, where each iteration performs the hash function on a particular sub-key.

At block 404, the logic flow 400 includes performing a direct match operation to determine whether a sub-key matches an element of at least one of one or more entries in the hash table, at a location having the greatest number of misses determined during the training procedure. Thus, if location three, e.g. iteration three, produced the greatest number of misses during training, the third sub-key of the search is compared against the third element of each entry in the hash table. If a miss occurs, the processing the search key may halt and the entire operation may be indicated as a miss or failure. Note that this direct match is performed prior to any sub-keys being processed by a hash function. Thus, misses may be detected earlier than and use less processing cycles than when one or more sub-key hash values are generated.

If at block 404 a hit occurs, the logic flow 400 may include determining whether any additional locations may be utilized to perform a direct match at block 406. For example, the location or iteration having the next most misses may be used to perform a direct match at block 404. These operations 404 and 406 may repeat until a miss occurs or no locations exist to perform direct matches. In some instances, the number of iterations of direct matches may be limited based on the overhead of performing a direct match and the higher chances to catch an early miss. If no additional locations exist to perform a direct match at block 406, the logic flow 400 includes performing a hash function on a sub-key of the search key at block 408. The hash function may be any hash function, and embodiments are not limited in this manner. Examples of hash functions include, but are not limited to, Murmur hash, Jenkins hash, Zobrist hash, Pearson hash, Buz hash, City hash, Spooky hash, Bernstein hash, Highway hash, and so forth.

At optional block 410, an iteration check may be performed, which may include determining whether the sub-key hash value generated based on the hash function performed on a sub-key matches any corresponding element hash values of elements of entries in the hash table. If the sub-key hash value does not match any element hash values, a miss occurs, and the process may result in a miss for the search key.

In embodiments, if a hit occurs at optional block 410, the logic flow 400 may include determining whether a hash value for the search key is complete, e.g. each of the sub-key hash values has been determined for each of the sub-keys of the search key at block 412. If the hash value is not complete, the logic flow 400 may include performing another iteration and operations 408, 410, and 412 until sub-key hash values have been generated for each of the sub-keys of the search key or a miss occurs. If the hash value for the search key is complete at block 412, the logic flow 400 may include comparing the search key with the entry in the table pointed to by the hash value of the search key to determine if the entry is present and matches the search key at block 414. If the entry is missing, e.g. the table does not have an entry at the location pointed to by the hash value, a miss has occurred. A miss also occurs when an entry is present but does not match the search key. A hit occurs when the entry at the location determined by the hash value matches the search key.

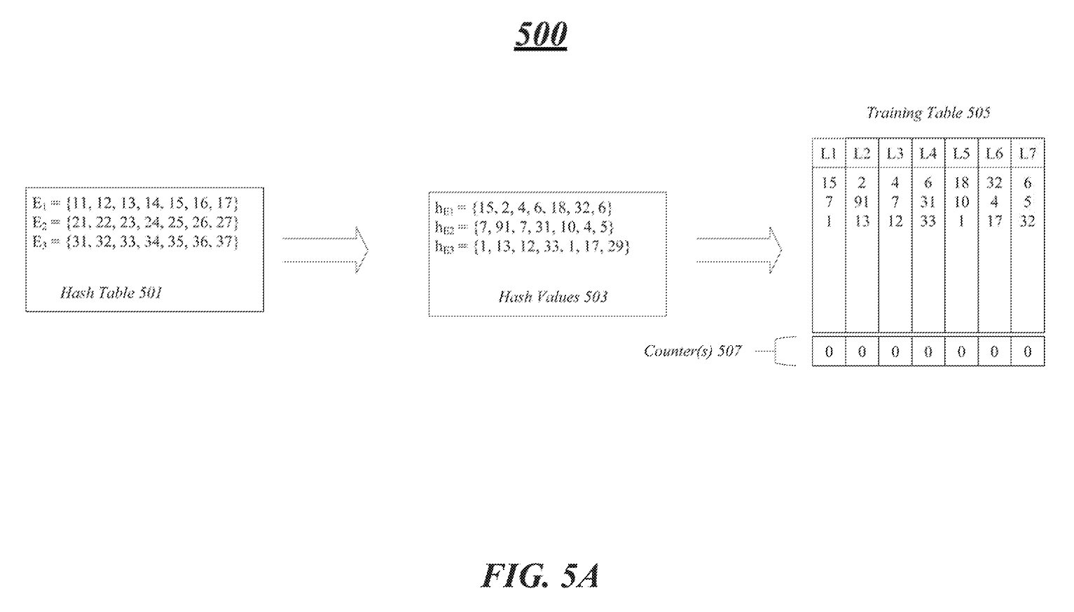

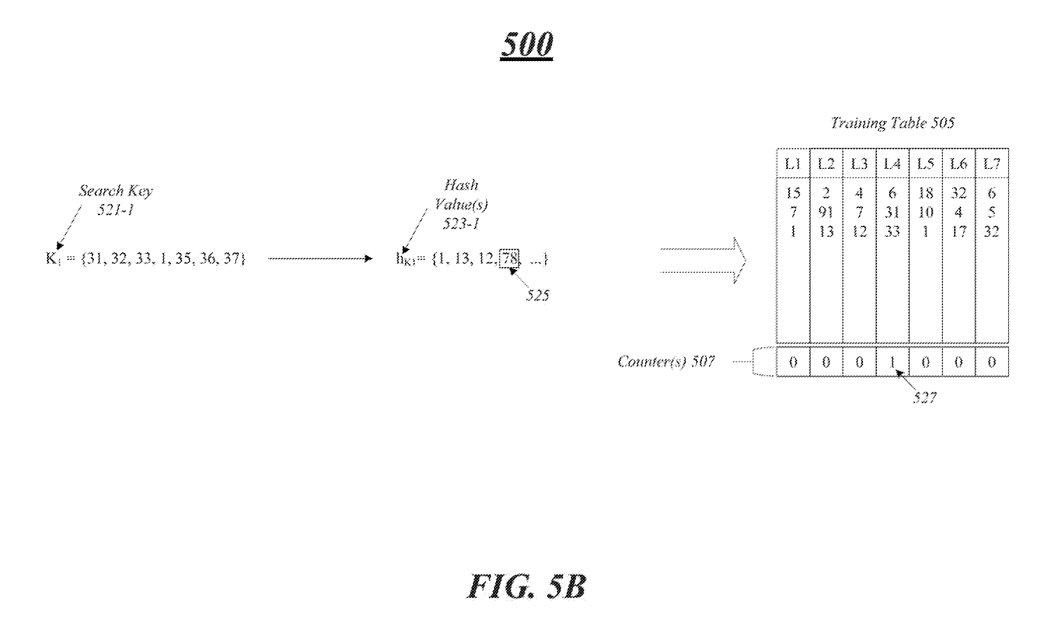

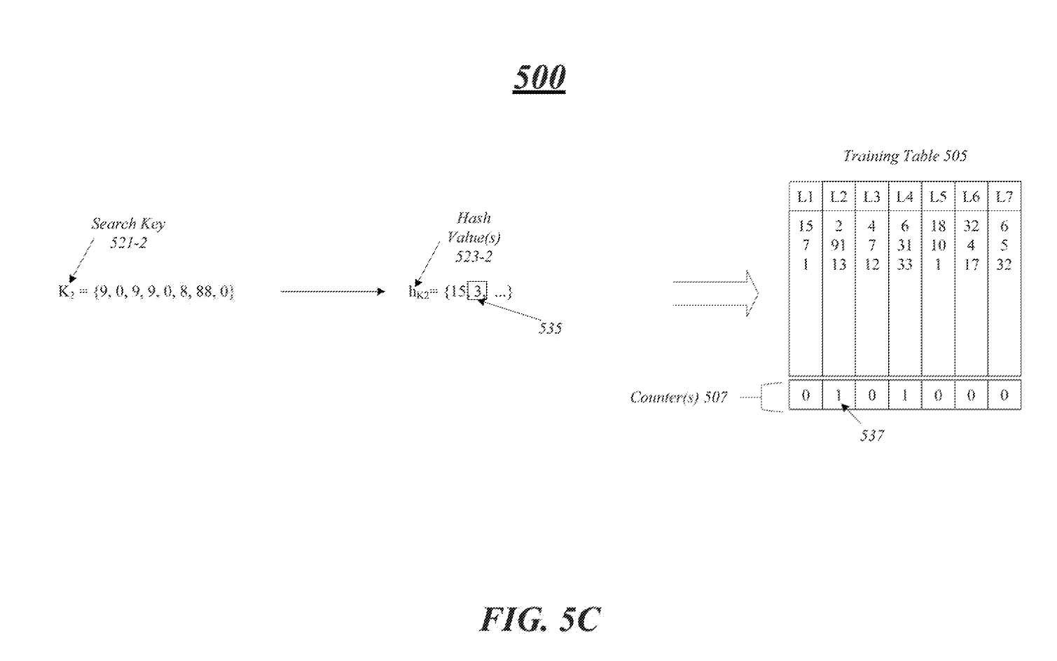

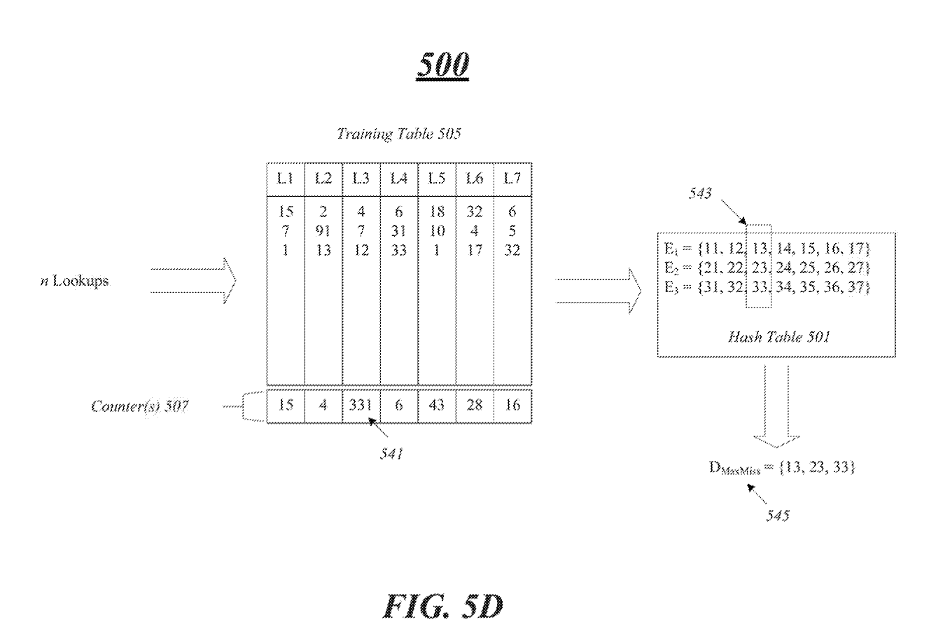

FIGS. 5A-5D illustrate an example flow diagram 500 during a training procedure to determine a location of maximum misses and corresponding elements of entries. FIGS. 5A-5D illustrate one possible example, and embodiments are not limited in this manner. FIG. 5A illustrates a hash table 501 including a number of entries, three in this example. The entries include a number of elements which may be alphanumeric characters. In embodiments, the training procedure may generate hash values 503 of each entry, resulting in element hash values. For example, the element hash values h_{E1} may be generated for entry E₁. Further, the training procedure may include generating data structure, such as training table 505 having a number of lists based on the number of element hash value elements. In this example, the training table 505 includes seven lists, one for each of the hash value elements. The first element of each of entry may be inserted into the first list, the second element of each entry may be inserted in the second list, and so on. The training table 505 may be populated with the element hash values for each of the entries in the hash table 501, as illustrated in FIG. 5A. Further, each of the lists may be associated with counters 507 to track misses associated with each of the lists of the element hash values, as will be discussed in more detail.

FIG. 5B illustrates an example of processing search key 521-1 as part of the training procedure. The search key 521-1 may include a number of sub-keys. The training procedure may include generating sub-key hash values 523-1 for each of the sub-keys of the search key 521-1 and comparing the sub-key hash values 531-1 with the element hash values in the training table 505 until one is not found and update training information or until all the sub-key are processed. In this example, the first sub-key hash value is ‘1’ and is in the first list of the training table 505. The second sub-key hash value is ‘13’ and is also is the second list of the training table 505. The third sub-key hash value is ‘12’ and is the third list of the training table 505. The fourth sub-key hash value is ‘78’ as identified by identifier 525 and is not in the fourth list of the training table 505. Thus, the counter 507 associated with the fourth list is increased by one, as identified by the identifier 527.

FIG. 5C illustrates an example of processing another search key 521-2 as part of the training procedure. The training procedure may include generating sub-key hash values 523-2 for each of the sub-keys of the search key 521-2 and comparing the sub-key hash values 531-2 with the element hash values in the training table 505 until one is not found and update training information or until all of the sub-key are processed. In this example, the first sub-key hash value is ‘15’ and is in the first list of the training table 505. The second sub-key hash value is ‘3’ as identified by identifier 535 and is not in the second list of the training table 505. Thus, the counter 507 associated with the second list is increased by one, as identified by the identifier 537. This process may be repeated any number of times until the training procedure is complete. FIG. 5D illustrates the results of the training table of n lookups have been performed for n search keys. In this example counter 507 associated with the third list indicates the location or iteration is having the most misses when processing the n search keys, as identified identifier 541. Thus, in this example, the third elements of the entries in the hash table 501 may be used to do a direct match operation, as indicated by identifiers 543 and 545. For example, D_{MaxMiss}={13, 23, 33}, the elements of the entries in the hash table 501 at the third location. Note that embodiments are not limited to only determining the location of the maximum misses, the location of the next maximum misses may be determined and utilized during a direct match operation, and so forth. Note that the output of the training procedure may be used for a number of purposes including, but not limited to, performing a direct match operation, traffic profiling to identify and reporting the portion or sub-key of a search-key with the highest probability of a miss, and reducing the number of lists when iteration checking is used to process search key. For example, the lists with the lower number of misses may be discarded for the evaluation.

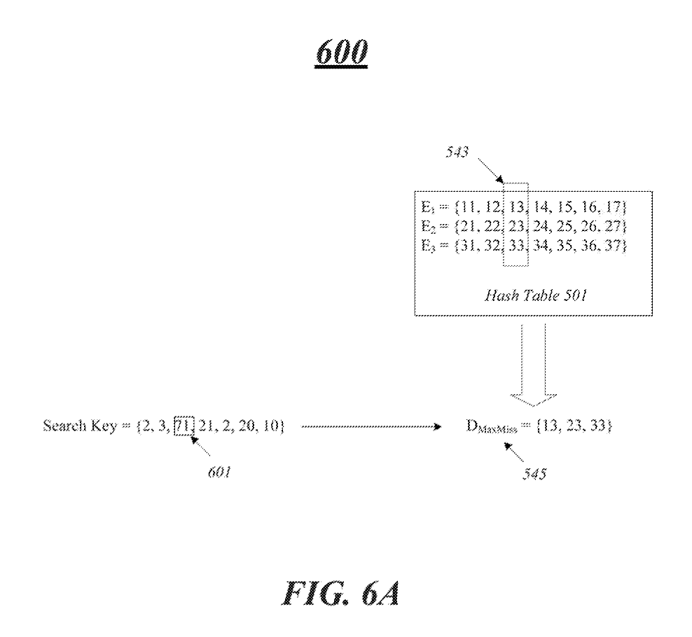

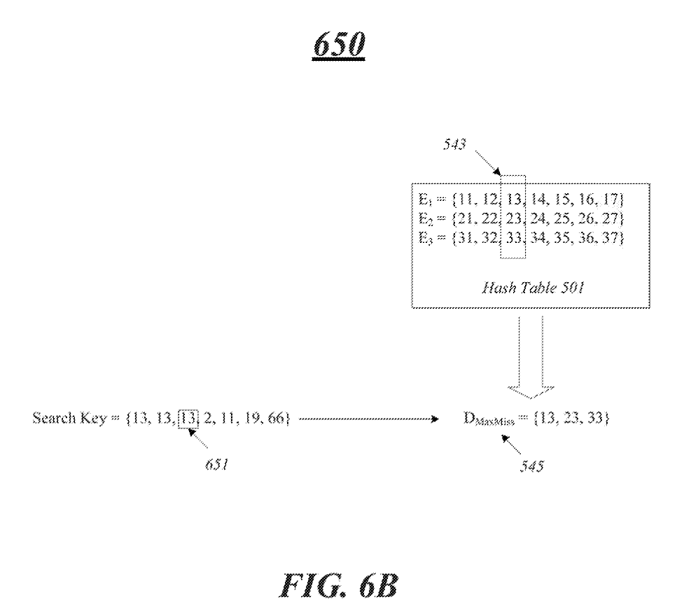

FIG. 6A illustrates an example flow diagram 600 to perform a direct match operation based on the training procedure performed in FIGS. 5A-5D. The direct match operation may be performed when a search key is being processed during a lookup in a hash table. The direct match operation may be used to detect a miss early in the processing of the search as discussed in FIG. 4 and in this example. As discussed in FIGS. 5A-5D, the elements in the third location, processed during the third iteration of the training procedure, were identified as having the highest likelihood of causing a miss.

In embodiments, the direct match operation may compare the sub-key at the location identified as having the highest likelihood of causing a miss against the elements at that location in the hash table's entries. In this example, ‘71’ as identified by identifier 601, may be compared against D_{MaxMiss}={13, 23, 33}, the elements at the location identified to have the highest likelihood of causing a miss. In this example, the sub-key of the search key does not match any of the elements of the entries at the location. Thus, the search may be identified as causing a miss prior to a hash function be performed on any of the sub-key of the search key.

FIG. 6B illustrates an example flow diagram 650 to perform a direct match operation based on the training procedure performed in FIGS. 5A-5D. The direct match operation may be used to detect a miss early in the processing of the search as discussed in FIG. 4 and in this example. As discussed in FIGS. 5A-5D, the elements in the third location, processed during the third iteration of the training procedure, were identified as having the highest likelihood of causing a miss.

In embodiments, the direct match operation may compare the sub-key at the location identified as having the highest likelihood of causing a miss against the elements at that location in the hash table's entries. In this example, ‘13’ as identified by identifier 651, may be compared against D_{MaxMiss}={13, 23, 33}, the elements at the location identified to have the highest likelihood of causing a miss. In this example, the sub-key of the search key does match one of the elements of the entries at the location. Thus, processing of the search key may continue, and the direct match operation did not remove the search key from consideration. In some instances, the processing of the search key may continue, and a match in the hash table may be found once all of the sub-key hashes have generated. In some instances, the processing of the search key may fail during an iteration check while less than all the sub-key hash values have been generated. For example, when iteration check is enabled, and a sub-key hash value does not match an element hash value during an iteration. In even other instances, once all the sub-key hash values are generated and compared with element hash values the search key cause a miss. Embodiments are not limited to these examples.

In embodiments, each of the entries utilized to perform the direct match operation, e.g. D_{MaxMiss}, may be short or less than the search key length. For example, each entry may be the length of a sub-key of a search key and can be processed during one hash function iteration. During processing and performing the direct match operation the array having the entries (D_{MaxMiss}) may be prefetched into cache to mitigate the overhead of multiple sequential memory accesses and branch mispredictions. Further, the direct match operation may be performed in parallel while hash values are generated for the sub-keys of a search key. For example, one core may perform the direct match operation while another core may proceed with generating sub-key hash values. In another example, a different processor or processing board (accelerator) may be utilized to process the direct match operation while another processor is processing the sub-key hash values. When a miss is determined by the direct match operation, the parallel processing of the sub-key hash values may be halted saving memory and processing resource usage.

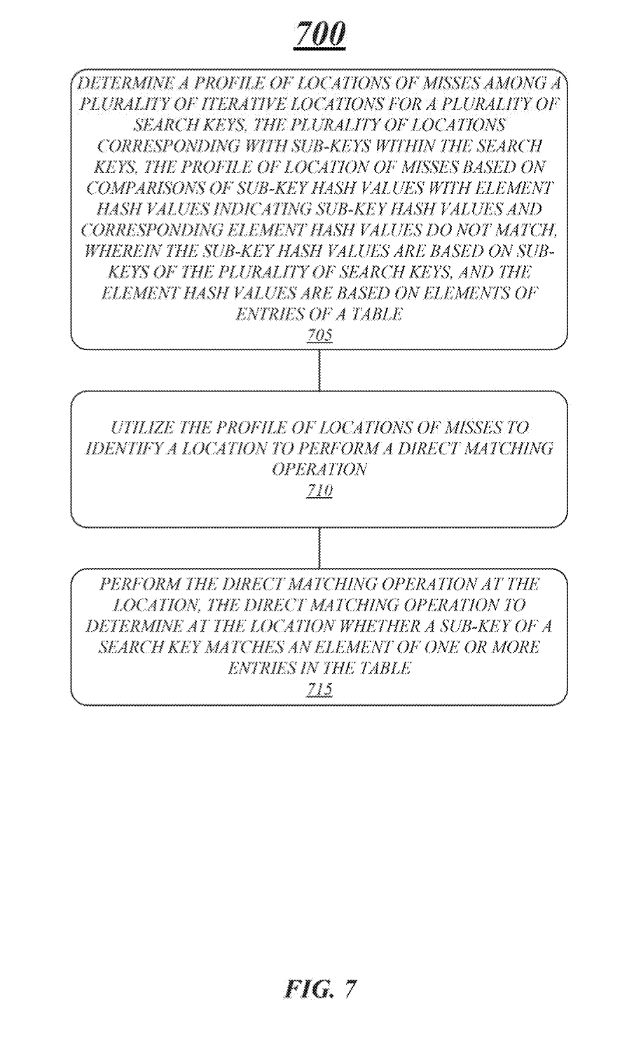

FIG. 7 illustrates an example of a first logic flow 700 that may be representative of some or all of the operations executed by one or more embodiments described herein. For example, the logic flow 700 may illustrate operations performed by circuitry, as described herein.

At block 705, the logic flow 700 may include determining a profile of locations of misses among a plurality of iterative locations for a plurality of search keys, the plurality of locations corresponding with sub-keys within the search keys, the profile of location of misses based on comparisons of sub-key hash values with element hash values indicating sub-key hash values and corresponding element hash values do not match, wherein the sub-key hash values are based on sub-keys of the plurality of search keys, and the element hash values are based on elements of entries of a table. In embodiments, the profile of locations of misses may be generated during a training procedure and indicates a probability that a miss will occur for each location or iteration for processing a search key. Thus, each location or iteration will have a corresponding probability that a miss will occur when processing a search key. At block 710, the logic flow 700 includes utilizing the profile of locations of misses to identify a location to perform a direct match operation. In one example, the location corresponding with the highest probability that a miss will occur is chosen to perform a direct match operation.

At block 715, the logic flow 700 includes performing the direct match operation at the location, the direct match operation to determine at the location whether a sub-key of a search key matches an element of one or more entries in the table. As previously discussed, the profile and the direct match operation may be used to to attempt to determine whether a search key is a hit or miss earlier in the processing cycle, e.g. before a number of iterations to calculate sub-key hash values are performed.

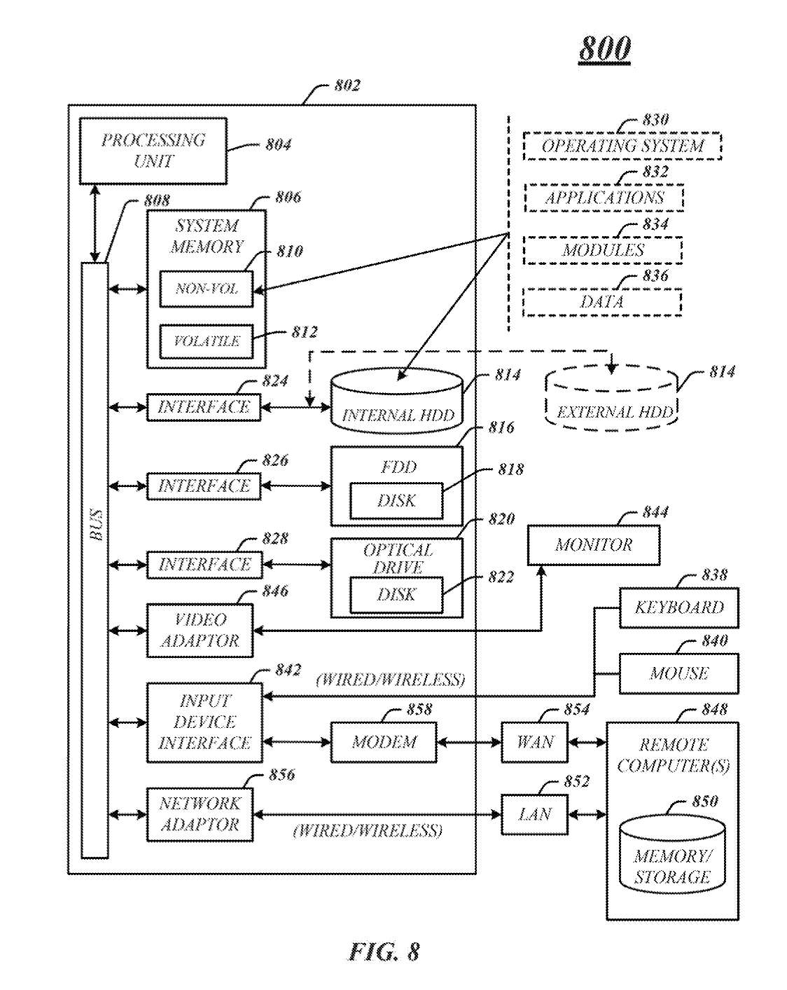

FIG. 8 illustrates an embodiment of an exemplary computing architecture 800 suitable for implementing various embodiments as previously described. In embodiments, the computing architecture 800 may include or be implemented as part of a node, for example.

As used in this application, the terms “system” and “component” are intended to refer to a computer-related entry, either hardware, a combination of hardware and software, software, or software in execution, examples of which are provided by the exemplary computing architecture 800. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and thread of execution, and a component can be localized on one computer and distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 800 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 800.

As shown in FIG. 8, the computing architecture 800 includes a processing unit 804, a system memory 806 and a system bus 808. The processing unit 804 can be any of various commercially available processors such as discussed above with respect to processor circuit 102.

The system bus 808 provides an interface for system components including, but not limited to, the system memory 806 to the processing unit 804. The system bus 808 can be any of several types of bus structure that may further interconnect to a memory bus (with or without a memory controller), a peripheral bus, and a local bus using any of a variety of commercially available bus architectures. Interface adapters may connect to the system bus 808 via slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computing architecture 800 may include or implement various articles of manufacture. An article of manufacture may include a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 806 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 8, the system memory 806 can include non-volatile memory 810 and volatile memory 812. A basic input/output system (BIOS) can be stored in the non-volatile memory 810.

The computer 802 may include various types of computer-readable storage media in the form of one or more lower speed memory units, including an internal (or external) hard disk drive (HDD) 814, a magnetic floppy disk drive (FDD) 816 to read from or write to a removable magnetic disk 818, and an optical disk drive 820 to read from or write to a removable optical disk 822 (e.g., a CD-ROM or DVD). The HDD 814, FDD 816 and optical disk drive 820 can be connected to the system bus 808 by an HDD interface 824, an FDD interface 826 and an optical drive interface 828, respectively. The HDD interface 824 for external drive implementations can include at least one or both of Universal Serial Bus (USB) and IEEE 1394 interface technologies.

The drives and associated computer-readable media provide volatile and nonvolatile storage of data, data structures, computer-executable instructions, and so forth. For example, a number of program modules can be stored in the drives and memory units 810, 812, including an operating system 830, one or more application programs 832, other program modules 834, and program data 836. In one embodiment, the one or more application programs 832, other program modules 834, and program data 836 can include, for example, the various applications and components of the system 700.

A user can enter commands and information into the computer 802 through one or more wire/wireless input devices, for example, a keyboard 838 and a pointing device, such as a mouse 840. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, track pads, sensors, styluses, and the like. These and other input devices are often connected to the processing unit 804 through an input device interface 842 that is coupled to the system bus 808, but can be connected by other interfaces such as a parallel port, IEEE 1394 serial port, a game port, a USB port, an IR interface, and so forth.

A monitor 844 or other type of display device is also connected to the system bus 808 via an interface, such as a video adaptor 846. The monitor 844 may be internal or external to the computer 802. In addition to the monitor 844, a computer typically includes other peripheral output devices, such as speakers, printers, and so forth.

The computer 802 may operate in a networked environment using logical connections via wire and wireless communications to one or more remote computers, such as a remote computer 848. The remote computer 848 can be a workstation, a server computer, a router, a personal computer, portable computer, microprocessor-based entertainment appliance, a peer device or other common network node, and typically includes many or all of the elements described relative to the computer 802, although, for purposes of brevity, only a memory/storage device 850 is illustrated. The logical connections depicted include wire/wireless connectivity to a local area network (LAN) 852 and larger networks, for example, a wide area network (WAN) 854. Such LAN and WAN networking environments are commonplace in offices and companies and facilitate enterprise-wide computer networks, such as intranets, all of which may connect to a global communications network, for example, the Internet.

When used in a LAN networking environment, the computer 802 is connected to the LAN 852 through a wire and/or wireless communication network interface or adaptor 856. The adaptor 856 can facilitate wire and/or wireless communications to the LAN 852, which may also include a wireless access point disposed thereon for communicating with the wireless functionality of the adaptor 856.

When used in a WAN networking environment, the computer 802 can include a modem 858, or is connected to a communications server on the WAN 854, or has other means for establishing communications over the WAN 854, such as by way of the Internet. The modem 858, which can be internal or external and a wire and/or wireless device, connects to the system bus 808 via the input device interface 842. In a networked environment, program modules depicted relative to the computer 802, or portions thereof, can be stored in the remote memory/storage device 850. It will be appreciated that the network connections shown are exemplary and other means of establishing a communications link between the computers can be used.

The computer 802 is operable to communicate with wire and wireless devices or entries using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11x (a, b, g, n, etc.) to provide secure, reliable, fast wireless connectivity. A Wi-Fi network can be used to connect computers to each other, to the Internet, and to wire networks (which use IEEE 802.3-related media and functions).

The various elements of the devices as previously described with reference to FIGS. 1-8 may include various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The detailed disclosure now turns to providing examples that pertain to further embodiments. Examples one through thirty-six provided below are intended to be exemplary and non-limiting.

In a first example, a system, a device, an apparatus, and so forth may include a processor determine a profile of locations of misses among a plurality of iterative locations for a plurality of search keys, the plurality of locations corresponding with sub-keys within the search keys, the profile of location of misses based on comparisons of sub-key hash values with element hash values indicating sub-key hash values and corresponding element hash values do not match, wherein the sub-key hash values are based on sub-keys of the plurality of search keys, and the element hash values are based on elements of entries of a table, utilize the profile of locations of misses to identify a location to perform a direct match operation, and perform the direct match operation at the location, the direct match operation to determine at the location whether a sub-key of a search key matches an element of one or more entries in the table.

In a second example and in furtherance of the first example, a system, a device, an apparatus, and so forth to include a processor to iteratively determine sub-key hash values for a search key to detect a miss, the miss to occur when a sub-key hash value does not match an element hash value at a same location, wherein the same location is one of the locations of misses.

In a third example and in furtherance of any previous example, a system, a device, an apparatus, and so forth to include a processor to cease determining sub-key hash values for the search key when a miss is detected.

In a fourth example and in furtherance of any previous example, a system, a device, an apparatus, and so forth to include a processor to determine a next location of the locations corresponding with a next greatest number of misses, and utilize the next location corresponding with the next greatest number of misses to determine whether another sub-key at the next location matches another element of one or more entries at the next location.

In a fifth example and in furtherance of any previous example, a system, a device, an apparatus, and so forth to include a processor to determine a number of misses for each of the locations of misses and perform a direct match operation between remaining sub-keys of a search key comprising the sub-key and elements of the one or more entries at each of the locations of misses in a decreasing order of the number of misses.

In a sixth example and in furtherance of any previous example, a system, a device, an apparatus, and so forth to include a processor to determine sub-key hash values for the sub-key and remaining sub-keys of a search key if the sub-key matches the element.

In a seventh example and in furtherance of any previous example, a system, a device, an apparatus, and so forth to include a processor to perform an iteration check for a sub-key hash value corresponding to one of remaining sub-keys of a search key if the sub-key matches the element, the iteration check to determine whether the sub-key hash value matches a corresponding element hash value based on a comparison.

In an eighth example and in furtherance of any previous example, a system, a device, an apparatus, and so forth to include a processor to discard the search key comprising the remaining sub-keys if the iteration check indicates the sub-key hash value does not match the corresponding element hash value, and determine sub-key hash values for the sub-key and all of the remaining sub-keys of the search key if the sub-key hash value matches the corresponding element hash value.

In a ninth example and in furtherance of any previous example, a system, a device, an apparatus, and so forth to include a processor to discard a search key comprising the sub-key if the sub-key does not match the element.

In a tenth example and in furtherance of any previous example, a computer-implemented method may include determining locations of misses for search keys based on a comparison of sub-key hash values indicating corresponding element hash values do not match, wherein the sub-key hash values are based on sub-keys of the search keys, and the element hash values are based on elements of entries, determining a location of the locations of misses corresponding with a greatest number of misses, and utilizing the location corresponding with the greatest number of misses to determine whether a sub-key at the location matches an element of one or more entries at the location.

In an eleventh example and in furtherance of any previous example, a computer-implemented method may include iteratively determining sub-key hash values for a search key to detect a miss, the miss to occur when a sub-key hash value does not match an element hash value at a same location, wherein the same location is one of the locations of misses.

In a twelfth example and in furtherance of any previous example, a computer-implemented method may include ceasing determining sub-key hash values for the search key when a miss is detected.

In a thirteenth example and in furtherance of any previous example, a computer-implemented method may include determining a next location of the locations corresponding with a next greatest number of misses, and utilize the next location corresponding with the next greatest number of misses to determine whether another sub-key at the next location matches another element of one or more entries at the next location.

In a fourteenth example and in furtherance of any previous example, a computer-implemented method may include determining a number of misses for each of the locations of misses and perform a direct match operation between remaining sub-keys of a search key comprising the sub-key and elements of the one or more entries at each of the locations of misses in a decreasing order of the number of misses.

In a fifteenth example and in furtherance of any previous example, a computer-implemented method may include determining sub-key hash values for the sub-key and remaining sub-keys of a search key if the sub-key matches the element.

In a sixteenth example and in furtherance of any previous example, a computer-implemented method may include performing an iteration check for a sub-key hash value corresponding to one of remaining sub-keys of a search key if the sub-key matches the element, the iteration check to determine whether the sub-key hash value matches a corresponding element hash value based on a comparison.

In a seventeenth example and in furtherance of any previous example, a computer-implemented method may include discarding the search key comprising the remaining sub-keys if the iteration check indicates the sub-key hash value does not match the corresponding element hash value, and determining sub-key hash values for the sub-key and all of the remaining sub-keys of the search key if the sub-key hash value matches the corresponding element hash value.

In an eighteenth example and in furtherance of any previous example, a computer-implemented method may include discarding a search key comprising the sub-key if the sub-key does not match the element.

In a nineteenth example and in furtherance of any previous example, a non-transitory computer-readable storage medium, comprising a plurality of instructions, that when executed, enable processing circuitry to determine locations of misses for search keys based on a comparison of sub-key hash values indicating corresponding element hash values do not match, wherein the sub-key hash values are based on sub-keys of the search keys, and the element hash values are based on elements of entries, determine a location of the locations of misses corresponding with a greatest number of misses, and utilize the location corresponding with the greatest number of misses to determine whether a sub-key at the location matches an element of one or more entries at the location.

In a twentieth example and in furtherance of any previous example, a non-transitory computer-readable storage medium, comprising a plurality of instructions, that when executed, enable processing circuitry to iteratively determine sub-key hash values for a search key to detect a miss, the miss to occur when a sub-key hash value does not match an element hash value at a same location, wherein the same location is one of the locations of misses.

In a twenty-first example and in furtherance of any previous example, a non-transitory computer-readable storage medium, comprising a plurality of instructions, that when executed, enable processing circuitry to cease determining sub-key hash values for the search key when a miss is detected.

In a twenty-second example and in furtherance of any previous example, a non-transitory computer-readable storage medium, comprising a plurality of instructions, that when executed, enable processing circuitry to determine a next location of the locations corresponding with a next greatest number of misses, and utilize the next location corresponding with the next greatest number of misses to determine whether another sub-key at the next location matches another element of one or more entries at the next location.

In a twenty-third example and in furtherance of any previous example, a non-transitory computer-readable storage medium, comprising a plurality of instructions, that when executed, enable processing circuitry to determine a number of misses for each of the locations of misses and perform a direct match operation between remaining sub-keys of a search key comprising the sub-key and elements of the one or more entries at each of the locations of misses in a decreasing order of the number of misses.

In a twenty-fourth example and in furtherance of any previous example, a non-transitory computer-readable storage medium, comprising a plurality of instructions, that when executed, enable processing circuitry to determine sub-key hash values for the sub-key and remaining sub-keys of a search key if the sub-key matches the element.

In a twenty-fifth example and in furtherance of any previous example, a non-transitory computer-readable storage medium, comprising a plurality of instructions, that when executed, enable processing circuitry to perform an iteration check for a sub-key hash value corresponding to one of remaining sub-keys of a search key if the sub-key matches the element, the iteration check to determine whether the sub-key hash value matches a corresponding element hash value based on a comparison.

In a twenty-sixth example and in furtherance of any previous example, a non-transitory computer-readable storage medium, comprising a plurality of instructions, that when executed, enable processing circuitry to discard the search key comprising the remaining sub-keys if the iteration check indicates the sub-key hash value does not match the corresponding element hash value, and determine sub-key hash values for the sub-key and all of the remaining sub-keys of the search key if the sub-key hash value matches the corresponding element hash value.

In a twenty-seventh example and in furtherance of any previous example, a non-transitory computer-readable storage medium, comprising a plurality of instructions, that when executed, enable processing circuitry to discard a search key comprising the sub-key if the sub-key does not match the element.

In a twenty-eighth example and in furtherance of any previous example, a system, a device, an apparatus, and so forth to include means for determining locations of misses for search keys based on a comparison of sub-key hash values indicating corresponding element hash values do not match, wherein the sub-key hash values are based on sub-keys of the search keys, and the element hash values are based on elements of entries, means for determining a location of the locations of misses corresponding with a greatest number of misses, and means for utilizing the location corresponding with the greatest number of misses to determine whether a sub-key at the location matches an element of one or more entries at the location.

In a twenty-ninth example and in furtherance of any previous example, a system, a device, an apparatus, and so forth to include means for iteratively determining sub-key hash values for a search key to detect a miss, the miss to occur when a sub-key hash value does not match an element hash value at a same location, wherein the same location is one of the locations of misses.

In a thirtieth example and in furtherance of any previous example, a system, a device, an apparatus, and so forth to include means for ceasing determining sub-key hash values for the search key when a miss is detected.

In a thirty-first example and in furtherance of any previous example, a system, a device, an apparatus, and so forth to include means for determining a next location of the locations corresponding with a next greatest number of misses, and utilize the next location corresponding with the next greatest number of misses to determine whether another sub-key at the next location matches another element of one or more entries at the next location.

In a thirty-second example and in furtherance of any previous example, a system, a device, an apparatus, and so forth to include means for determining a number of misses for each of the locations of misses and perform a direct match operation between remaining sub-keys of a search key comprising the sub-key and elements of the one or more entries at each of the locations of misses in a decreasing order of the number of misses.

In a thirty-third example and in furtherance of any previous example, a system, a device, an apparatus, and so forth to include means for determining sub-key hash values for the sub-key and remaining sub-keys of a search key if the sub-key matches the element.

In a thirty-fourth example and in furtherance of any previous example, a system, a device, an apparatus, and so forth to include means for performing an iteration check for a sub-key hash value corresponding to one of remaining sub-keys of a search key if the sub-key matches the element, the iteration check to determine whether the sub-key hash value matches a corresponding element hash value based on a comparison.

In a thirty-fifth example and in furtherance of any previous example, a system, a device, an apparatus, and so forth to include means for discarding the search key comprising the remaining sub-keys if the iteration check indicates the sub-key hash value does not match the corresponding element hash value, and means for determining sub-key hash values for the sub-key and all of the remaining sub-keys of the search key if the sub-key hash value matches the corresponding element hash value.

In a thirty-sixth example and in furtherance of any previous example, a system, a device, an apparatus, and so forth to include means for discarding a search key comprising the sub-key if the sub-key does not match the element.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

What is claimed is:

1. An apparatus, comprising:
a processor circuit; and
memory comprising logic, that when executed by the processor circuit, to cause the processor circuit to:
determine a profile of locations of misses among a plurality of iterative locations for a plurality of search keys, the plurality of locations corresponding with sub-keys within the search keys, the profile of location of misses based on comparisons of sub-key hash values with element hash values indicating sub-key hash values and corresponding element hash values do not match, wherein the sub-key hash values are based on sub-keys of the plurality of search keys, and the element hash values are based on elements of entries of a table;
utilize the profile of locations of misses to identify a location to perform a direct match operation; and
perform the direct match operation at the location, the direct match operation to determine at the location whether a sub-key of a search key matches an element of one or more entries in the table.

2. The apparatus of claim 1, the logic to cause the processor circuit to determine the profile of locations of misses comprising iteratively determining sub-key hash values for a search key to detect a miss, the miss to occur when a sub-key hash value does not match an element hash value, at a same location, wherein the same location is one of the locations of misses.

3. The apparatus of claim 2, the logic to cause the processor circuit to cease determining sub-key hash values for the search key when a miss is detected.

4. The apparatus of claim 1, the logic to cause the processor circuit to identify the location having a highest probability of a miss based on the profile of the locations of misses.

5. The apparatus of claim 1, the logic to cause the processor circuit to perform direct match operations between remaining sub-keys of the search key and corresponding elements of the one or more entries in the table at each of the plurality of iterative locations of misses, the direct match operations to occur in an order of decreasing probability of misses based on the profile of the locations of the misses.

6. The apparatus of claim 1, the logic to cause the processor circuit to determine sub-key hash values for the sub-key and remaining sub-keys of a search key if the sub-key matches the element.

7. The apparatus of claim 1, the logic to cause the processor circuit to perform an iteration check for a sub-key hash value corresponding to one of remaining sub-keys of the search key if the sub-key matches the element, the iteration check to determine whether the sub-key hash value matches a corresponding element hash value based on a comparison.

8. The apparatus of claim 7, the logic to cause the processor circuit to:
discard the search key comprising the remaining sub-keys if the iteration check indicates the sub-key hash value does not match the corresponding element hash value; and
determine sub-key hash values for the sub-key and all of the remaining sub-keys of the search key if the sub-key hash value matches the corresponding element hash value.

9. The apparatus of claim 1, the logic to cause the processor to discard the search key comprising the sub-key if the sub-key does not match the element.

10. The apparatus of claim 1, wherein the processor circuit comprises one of a field-programmable gate array (FPGA) device, an application-specific integrated circuit (ASIC) device, and a co-processor device.

11. A computer-implemented method, comprising:
determining a profile of locations of misses among a plurality of iterative locations for a plurality of search keys, the plurality of locations corresponding with sub-keys within the search keys, the profile of location of misses based on comparisons of sub-key hash values with element hash values indicating sub-key hash values and corresponding element hash values do not match, wherein the sub-key hash values are based on sub-keys of the plurality of search keys, and the element hash values are based on elements of entries of a table;
utilizing the profile of locations of misses to identify a location to perform a direct match operation; and
performing the direct match operation at the location, the direct match operation to determine at the location whether a sub-key of a search key matches an element of one or more entries in the table.

12. The computer-implemented method of claim 11, comprising determining the profile of locations of misses comprising iteratively determining sub-key hash values for a search key to detect a miss, the miss to occur when a sub-key hash value does not match an element hash value, at a same location, wherein the same location is one of the locations of misses.

13. The computer-implemented method of claim 12, comprising ceasing determining sub-key hash values for the search key when a miss is detected.

14. The computer-implemented method of claim 11, comprising identifying the location having a highest probability of a miss based on the profile of the locations of misses.

15. The computer-implemented method of claim 11, comprising performing direct match operations between remaining sub-keys of the search key and corresponding elements of the one or more entries in the table at each of the plurality of iterative locations of misses, the direct match operations to occur in an order of decreasing probability of misses based on the profile of the locations of the misses.

16. The computer-implemented method of claim 11, comprising determining sub-key hash values for the sub-key and remaining sub-keys of a search key if the sub-key matches the element.

17. The computer-implemented method of claim 11, comprising performing an iteration check for a sub-key hash value corresponding to one of remaining sub-keys of the search key if the sub-key matches the element, the iteration check to determine whether the sub-key hash value matches a corresponding element hash value based on a comparison.

18. The computer-implemented method of claim 17, comprising:
discarding the search key comprising the remaining sub-keys if the iteration check indicates the sub-key hash value does not match the corresponding element hash value; and
determining sub-key hash values for the sub-key and all of the remaining sub-keys of the search key if the sub-key hash value matches the corresponding element hash value.

19. The computer-implemented method of claim 11, comprising discarding the search key comprising the sub-key if the sub-key does not match the element.

20. A non-transitory computer-readable storage medium, comprising a plurality of instructions, that when executed, enable processing circuitry to:
determine a profile of locations of misses among a plurality of iterative locations for a plurality of search keys, the plurality of locations corresponding with sub-keys within the search keys, the profile of location of misses based on comparisons of sub-key hash values with element hash values indicating sub-key hash values and corresponding element hash values do not match, wherein the sub-key hash values are based on sub-keys of the plurality of search keys, and the element hash values are based on elements of entries of a table;
utilize the profile of locations of misses to identify a location to perform a direct match operation; and
perform the direct match operation at the location, the direct match operation to determine at the location whether a sub-key of a search key matches an element of one or more entries in the table.

21. The computer-readable storage medium of claim 20, comprising a plurality of instructions, that when executed, enable processing circuitry to determine the profile of locations of misses comprising iteratively determining sub-key hash values for a search key to detect a miss, the miss to occur when a sub-key hash value does not match an element hash value, at a same location, wherein the same location is one of the locations of misses.

22. The computer-readable storage medium of claim 21, comprising a plurality of instructions, that when executed, enable processing circuitry to cease determining sub-key hash values for the search key when a miss is detected.

23. The computer-readable storage medium of claim 20, comprising a plurality of instructions, that when executed, enable processing circuitry to perform direct match operations between remaining sub-keys of the search key and corresponding elements of the one or more entries in the table at each of the plurality of iterative locations of misses, the direct match operations to occur in an order of decreasing probability of misses based on the profile of the locations of the misses.

24. The computer-readable storage medium of claim 20, comprising a plurality of instructions, that when executed, enable processing circuitry to determine sub-key hash values for the sub-key and remaining sub-keys of a search key if the sub-key matches the element.

25. The computer-readable storage medium of claim 20, comprising a plurality of instructions, that when executed, enable processing circuitry to perform an iteration check for a sub-key hash value corresponding to one of remaining sub-keys of the search key if the sub-key matches the element, the iteration check to determine whether the sub-key hash value matches a corresponding element hash value based on a comparison.

26. The computer-readable storage medium of claim 20, comprising a plurality of instructions, that when executed, enable processing circuitry to perform an iteration check for a sub-key hash value corresponding to one of remaining sub-keys of the search key if the sub-key matches the element, the iteration check to determine whether the sub-key hash value matches a corresponding element hash value based on a comparison.

27. The computer-readable storage medium of claim 26, comprising a plurality of instructions, that when executed, enable processing circuitry to:
discard the search key comprising the remaining sub-keys if the iteration check indicates the sub-key hash value does not match the corresponding element hash value; and
determine sub-key hash values for the sub-key and all of the remaining sub-keys of the search key if the sub-key hash value matches the corresponding element hash value.

28. The computer-readable storage medium of claim 20, comprising a plurality of instructions, that when executed, enable processing circuitry to discard the search key comprising the sub-key if the sub-key does not match the element.
